(19) United States
(12) Patent Application Publication
(10) Pub. No.: US 2005/0254824 A1
(43) Pub. Date: Nov. 17, 2005

(54) Synchronized Digital Clock System

(76) Inventor: John G. Bode, Derby, KS (US)

Correspondence Address: GREENBERG & LIEBERMAN, 314 PHILADELPHIA AVE., TAKOMA PARK, MD, 20912, US

(21) Appl. No.: 10/908,573

(22) Filed: May 17, 2005

Related U.S. Application Data
(60) Provisional application No. 60/521,536, filed on May 17, 2004.

(51) Int. Cl. H04B 10/00

(52) U.S. Cl. 398/154

(57) ABSTRACT

A system for updating clocks required to keep very accurate time. A first clock receives infrared time correction from a second clock serving as a calibration device. The first clock, upon receipt of the infrared time correction, can then send a signal—audible, visual, or an infrared signal to confirm that the time correction has been received.

### CONTINUITY DATA AND PRIORITY CLAIM

Priority is hereby claimed to patent application No. 60/521,536 filed on May 17, 2004.

### FIELD OF THE INVENTION

The present invention relates to ensuring proper time on clocks, and more particularly, the present invention is a digital clock that receives time correction via an infrared communication system.

### BACKGROUND OF THE INVENTION

Clocks are employed for personal reasons as well as for industrial applications. While the average consumer is not bothered by a time piece occasionally straying from the correct time, industrial applications require that a clock be as accurate as possible. Maintaining proper time is vital to various branches of the United States Government, most Fortune 1000 companies, hospitals, universities, manufacturing plants, and retail establishments.

One way to ensure that a clock maintains the proper time is to simply build it with extremely accurate parts. However, no matter how accurate the parts in the clock are, the clock cannot perfectly maintain the correct time over long periods of operation. Thus, there is a need to have a method of correcting clocks that are out of sync with the correct time.

Wireless communication, such as via radio waves, is a simple way to update clocks so that they display the correct time. Homes are usually wood frame dwellings or at least wood frame roof structures. Common radio controlled clocks will work in homes of such structure. However, industrial applications pose special problems for radio waves. Commercial buildings are usually concrete and/or steel with steel roof decking. Radio controlled clocks usually do not work in these buildings. Thus, there is a need for a method for updating clocks located where radio waves cannot reach the clocks.

In addition, commercial customers require higher accuracy in timekeeping than most consumers. Thus, there is a need to couple a highly accurate clock with a correction mechanism.

U.S. Pat. No. 6,567,344 issued to Auer on May 20, 2003, shows a method and apparatus for automatically displaying a correct time and date when initially activating a clock. After manufacture of the clock and before it is purchased by the user, a basic data set, including the time and geographical region data, are input to the clock via an interface. The data are stored in a memory of a microcontroller. After purchase by a user, the clock is plugged into a power grid and the correct time and date are displayed without the need to set the clock. In short, Aurer's device is a battery backed clock circuit to maintain the time while the clock is shipped to the customer. Accuracy is hardly mentioned. The only mention of correcting the time once the clock is purchased is that it may use the power line frequency as a time source. This is a common practice for inexpensive consumer clocks, but not reliable enough for commercial applications.

There is a need for ultra-high accuracy clocks that can maintain nearly flawless time to survive long periods without updating.

Aurer's device mentions an electromechanical connection to allow time updates before the clock is purchased, but does not allow for any further updates using this port by the customer. In practice, many clocks are employed at a job location, and using such a port would most likely be time consuming and tedious.

There is a need for quick updating of clocks that are in an environment impervious to radio transmission updating, as well as a need for quick updating of clocks that are too numerous to dock with on a one-on-one basis.

### SUMMARY OF THE INVENTION

The present invention is a clock that can be updated using infrared light. No switching time data to change geographical time zones is required. A personal computer is neither used or required to set the clock. A GPS master controller or ultra-high precision hand-held microcontroller is used to set clock. The end user can use a hand-held microcontroller with infrared data link to instantly adjust the time as needed (approximately every five years). This is of particular importance in a commercial setting where hundreds of clocks may need to be adjusted, with many of them out of reach.

### DETAILED DESCRIPTION

No electro-mechanical interface is used to enter the time data. The interface uses electromagnetic radiation in the form of infrared or radio data link. The interface does not utilize a personal computer. No geographic information is required. No time zone offsets or tables are required. No time zone selection is required. The microcontroller does not perform any calculations relating to time zones. No synchronization to the main power supply is required. The present invention uses an ultra-high precision temperature compensated AT-cut crystal oscillator for a time base and does not require connection to the power grid. Vehicular and battery power sources are also acceptable.

The present invention incorporates the ability for the end user to enable or disable automatic daylight saving time adjustments. A lookup table and date alone cannot be used to determine if and when daylight savings time is to be used. Changes in the law can alter daylight savings time rules. The present invention is designed to provide accurate time in structures that cannot receive radio time signals.

The present invention is approximately 20 to 200 times more accurate than a typical, non-radio controlled, battery powered clock for home use. The crystal oscillator in the present invention is more accurate than conventional clocks. Most, if not all, consumer clocks use low accuracy crystals or resonators without any type of compensation for temperature change.

A common radio controlled clock typically receives the time signal once per day. In between time updates (approximately 24 hours), a common radio controlled clock must run using its internal oscillator. Because of the poor accuracy, a common radio controlled clock must receive updates daily to maintain accuracy within a few seconds. Now, if that concept is employed, and the accuracy of the oscillator is increased, a radio controlled clock can go much longer between time updates.

For example, before clocks of the present invention are shipped to a customer, a radio time update is sent to the clocks. Then 5-8 years later, the customer updates the customer's clocks by sending another time update using a small handheld radio transmitter. The primary difference between the two clock update methods is the length of time between updates. In the present invention, because of radio interference or deflection, infrared or radio links in place of the electro-mechanical connection or wireless connection are employed, and thus the customer can easily update the clocks using a small calibration transmitter. This method is particularly important when clocks are up high and out of reach, common in commercial applications.

The components of the present invention are all conventional, and work together in conventional ways. There are essentially two clocks, the first clock is the one to be set, and the second clock is the one that has the correct time. The time is transferred from the second clock via a conventional infrared transmitter to the first clock. The first clock has a conventional infrared receiver to receive the time from the second clock. Once the first clock has received the time from the second clock, it is preferred that the first clock respond in some conventional fashion to alert the user of the present invention that the first clock has received the time from the second clock.

In the preferred embodiment of the present invention, the first clock has a conventional display that is used as a visual indicator of reception status. The conventional display simply blinks to indicate data reception.

In an alternative embodiment of the present invention, the first clock can show various numbers or messages on the conventional display to indicate more information about the data reception than is possible by simply blinking the conventional display.

In a third embodiment of the present invention, a conventional audible device may also be used as a data reception indicator, such that the first clock issues an audible alert when the first clock has received the time transfer from the second clock.

In a fourth embodiment of the present invention, the first clock sends an infrared signal back to the second clock. The first clock has a conventional infrared transmitter to send the infrared signal to the second clock. The infrared signal confirms, to the second clock, that the first clock received the time transfer. Audible and/or visual identification on the second clock can confirm that the first clock received the time transfer upon the second clock's receipt of the infrared signal from the first clock.

If there are multiple first clocks, each first clock can send a separate alert—whether visual, audible, or an actual infrared signal to the second clock—so that the user knows which clocks have received time correction. For example, each first clock in a different location would have a different tone or a different pattern of blinking. Alternatively, for example, with an infrared response, the second clock shows only the first clocks that have actually sent an infrared signal back to the second clock. Thus, if each first clock sends a distinct infrared signal that registered only for that individual first clock, the user of the second clock can easily determine which first clocks have not received the time from the second clock.

The present invention is not limited to the embodiment aforementioned, but is any and all embodiments within the scope of the following claims.

1. A method for setting clock time, comprising:
setting the time on a first clock, said first clock having an ultra-high precision temperature compensated AT-cut crystal oscillator and an infrared receiver; and
updating the time on said first clock via an infrared transmitter.

2. The method of claim 1, wherein said infrared transmitter is part of a second clock.

3. The method of claim 1, further comprising communicating update status from said first clock to a user.

4. The method of claim 3, wherein said communicating update status from said first clock to a user is done via a visual indicator.

5. The method of claim 3, wherein said communicating update status from said first clock to a user is done via an audible indicator.

6. The method of claim 3, wherein said communicating update status from said first clock to a user is done via infrared communication.

7. The method of claim 2, further comprising sending an infrared signal from said first clock to said second clock.
